(19) United States
(12) Patent Application Publication
(10) Pub. No.: US 2026/0346727 A1
(43) Pub. Date: Nov. 5, 2026

(54) ROAD UNEVENNESS DETECTION THROUGH EVALUATION OF THE OPERATING CURRENT OF AN ELECTRIC VEHICLE DRIVE

(71) Applicant: SCHAEFFLER TECHNOLOGIES AG & CO. KG, Herzogenaurach (DE)

(72) Inventors: Janos KEREKGYARTO, Regensburg (DE); Matthias TÖNS, Regensburg (DE)

(73) Assignee: SCHAEFFLER TECHNOLOGIES AG & CO. KG, Herzogenaurach (DE)

(21) Appl. No.: 19/117,570

(22) PCT Filed: Oct. 12, 2023
(86) PCT No.: PCT/EP2023/078274

§ 371 Date: Apr. 1, 2025

(30) Foreign Application Priority Data
Oct. 14, 2022 (DE) 10 2022 210 834.5

(51) Int. Cl. B60L 3/12; G01C 21/00; G07C 5/08

(52) U.S. Cl. CPC B60L 3/12; G01C 21/3822; G01C 21/3837; G07C 5/0825

(57) ABSTRACT

The condition of a roadway traveled by a vehicle with an electric drive is determined. The operating current of the electric drive is detected here. At least one current fluctuation in the operating current is ascertained. A roadway unevenness is detected on the basis of this. A signal is generated, which describes the location of occurrence of the current fluctuation and/or the roadway unevenness. The location of occurrence or the roadway unevenness is output as a roadway unevenness point. Furthermore, a corresponding computer program product is described.

### CROSS REFERENCE TO RELATED APPLICATIONS

This application is the U.S. National Phase Application of PCT International Application No. PCT/EP2023/078274, filed Oct. 12, 2023, which claims priority to German Patent Application No. 10 2022 210 834.5, filed Oct. 14, 2022, the contents of such applications being incorporated by reference herein.

### BACKGROUND OF THE INVENTION

Driving over unevennesses in roadways reduces comfort and may also lead to wear in the undercarriage. It is known to detect unevennesses such as potholes so as to be able to warn vehicles about potholes and possibly adapt the chassis for potholes or other unevennesses ahead.

It is known from printed document DE 10 2014 214 729A1, incorporated herein by reference, to ascertain potholes using level sensors or inertial sensors. These sensors are linked to additional hardware costs.

### SUMMARY OF THE INVENTION

An aspect of the invention provides a possible way of detecting roadway unevennesses in a cost-effective manner.

### DESCRIPTION OF EXEMPLARY EMBODIMENTS

It is proposed to detect roadway unevennesses on the basis of current fluctuations in the electric traction drive. It has been identified that driving over a roadway unevenness leads to torque changes in the drive; on the one hand, when driving into a deeper roadway point (unevenness), such as a pothole and, on the other, when driving back onto the roadway which is higher than the defect point in the roadway. The former leads to a temporary torque drop and the latter to a torque peak. These changes in torque can be identified in the current which flows through the electric drive during operation based on the electromotive properties of the electric drive (regenerative effects, repercussions of torque changes on the drive operating current). As a result, a roadway unevenness may be inferred through the ascertainment of current fluctuations. This enables cost-effective detection of roadway unevennesses and possibly the associated points at which they occur (roadway unevenness point), wherein this may also serve for adapting driving parameters of the drive or the chassis in preparation for a roadway unevenness and, in particular, for providing a database comprising points at which roadway unevennesses are located (roadway unevenness points).

A method for determining the condition of a roadway is described. The roadway is traveled by a vehicle having an electric drive. The electric drive here is a traction drive. The operating current of the electric drive is detected. It is possible here to refer to a measurement or other means of ascertaining the operating current, which forms part of an engine control or engine management procedure for the electric drive. The actual current values from the engine control may be output here as signals which describe the operating current, wherein these signals form the basis for ascertaining the at least one current fluctuation. The operating current may be detected as phase current of the electric machine of the electric drive or as a direct operating current of an inverter which feeds the electric machine (or also on the basis of variables in the engine management or control). The operating current may be detected by using control or management variables during the engine management or control. The ascertainment of the current fluctuation may be realized by detecting a fluctuation (indicating the roadway unevenness) in the control deviation of the engine control or on the basis of the setpoint/actual difference in the engine control or on the basis of harmonics in the operating current (which indicate a roadway unevenness). Since management or control variables are linked to the operating current or partially or fully describe this, they may also be referred to as operating current in respect of the detection procedure.

At least one current fluctuation which occurs in the operating current is ascertained. This current fluctuation is caused by driving across a roadway unevenness. A current fluctuation here does not refer to the change in the current generating the rotating field. Current fluctuations refer only to fluctuations relative to the setpoint operating current. The setpoint operating current here may be a (multiphase) phase current (alternating current) or a direct current for supplying an inverter, wherein a current fluctuation refers to the deviation relative to the setpoint curve of the current, i.e. a deviation relative to the setpoint three-phase current which flows in the electric drive machine of the drive as a phase current or a deviation relative to the direct current with which the inverter is supplied. The current fluctuation is therefore a change relative to the alternating phase current, or relative to the sinusoidal curve thereof, or a change in the direct supply current of the inverter. The current or the current fluctuation may be measured using a current sensor (shunt, Hall element, measuring transformer, . . . ) or the like. In particular, the current fluctuation may be ascertained by filtering the operating current using a high-pass filter or through correlation with signal forms which are characteristic of the effects on the operating current of an electric drive which are caused by driving over roadway unevennesses.

It is detected on the basis of the current fluctuation that the vehicle is driving over a roadway unevenness at the time of occurrence of the current fluctuation. It is detected on the basis of the current fluctuation that there is a roadway unevenness, wherein a variable (roadway quality) is output, which indicates the roadway unevenness, in particular the severity thereof, or that the roadway is uneven. This may be used—also independently of the location of occurrence—to set the chassis accordingly, to set a driving mode (for instance, the gas pedal sensitivity or sport mode or eco mode) and/or to output information which is accessible to the user and indicates road unevenness and possibly the severity or quality thereof. In particular, it is detected on the basis of the current fluctuation that the vehicle is located at a roadway unevenness point. The location in which the vehicle was or is located during the occurrence of the current fluctuation corresponds to the location of occurrence of the current fluctuation. The location of occurrence may be ascertained via a (preferably global) geolocation method, in particular a satellite-based and/or mobile-network-based geolocation method. A signal is generated, which describes the location of occurrence of the current fluctuation. The signal may include location information, in particular global location information or location information in a road on a map display. The signal describes at least the location of occurrence and may moreover describe the severity and/or the length (duration) of the current fluctuation or it may describe the severity of the roadway unevenness. The signal or the location of occurrence described thereby is output as a roadway unevenness point. In other words, the signal corresponds to the location of occurrence of the roadway unevenness point and may moreover describe the quality and/or quantity of the unevenness in the roadway. A signal is therefore generated and output which describes the location of occurrence of the current fluctuation. The signal may be output as a database entry.

The location of occurrence is preferably output to a database. The location of occurrence is stored in a database, preferably together with further data which indicate the roadway unevenness point (severity, length, size, . . . ) . The database may be located inside the vehicle, in particular in a navigation device of the vehicle. The database may be located in a mobile device which is designed to execute a navigation function. The navigation function is preferably combined with the database therein. As a result, the navigation device or the navigation function may display navigation data which are combined with the entries in the database. Furthermore, the database may be provided outside the vehicle, for instance as a database which may be accessed by a navigation device inside the vehicle. The navigation device retrieves entries from the database and combines these preferably with the navigation data (or displays) of the navigation device. Such a navigation device may be a device which is permanently installed in the vehicle (and is designed for suitable communication), or it may be a mobile device, which is designed for suitable communication and which is designed to execute a navigation function (for instance in the form of application software).

The duration (a time duration between two successive current fluctuations or the distance equivalent of the duration) or severity of the current fluctuation and/or the type of current fluctuation is/are preferably ascertained. From this, it is possible to derive a quality or quantity characteristic of the current fluctuation, which may be stored or output as a signal, in particular linked to the location of occurrence of the roadway unevenness point.

In particular, the duration (a time duration between two successive current fluctuations or the distance equivalent) and/or the type may be compared with a specified duration and/or type. During the comparison, a similarity value is preferably ascertained, which is a measure of the similarity between the ascertained and the specified duration and/or type. Different severities may be specified, so that it is possible to ascertain the specified severity with the greatest similarity to the ascertained severity. To ascertain the similarity, a correlation in the time or frequency range may be used, wherein the result of the correlation describes the similarity. Vectorial similarities may also be ascertained or similarities, in particular similarity values, may be ascertained on the basis of neural networks. Similarity values describe the extent of the similarity and increase along with the extent of the similarity. The location of occurrence is preferably only output if the similarity value exceeds a specified limit. As a result, roadway unevennesses detected as false positives may be filtered out.

Some embodiments provide that, before ascertaining the current fluctuation, current changes linked to a change in a setpoint speed, which are received via an operating interface, are removed from the operating current. Since such changes in the setpoint speed (corresponding to a setpoint acceleration) are known, these may be removed from the ascertained operating current through subtraction. Since current changes caused by such setpoint speed changes furthermore have a significantly lower rate of change than current fluctuations produced as a result of roadway unevennesses, the proportion of the current fluctuation which is attributed to setpoint speed changes may be suppressed by high-pass filtering or the like.

It may be provided that the ascertainment of the at least one current fluctuation in the operating current, the generation of the signal and/or the output of the location of occurrence only take place if the current fluctuation is ascertained at a vehicle speed above a specified speed threshold. In other words, if the speed of the vehicle is not above a specified speed threshold, the current fluctuation is not detected as roadway unevenness. This speed threshold may be, for example, 5 km/h or 2 km/h. It is thus avoided that a curb which is mounted when maneuvering into or out of a parking space is falsely detected as roadway unevenness.

The ascertainment of the at least one current fluctuation in the operating current preferably provides for the amplitude and/or rate of change and/or the frequency component to be calculated as a characteristic of the current fluctuation. This characteristic is mapped onto a torque change which occurs in the electric drive as a result of roadway unevenness, wherein the torque change is the cause of the current fluctuation. In particular, the amplitude and/or rate of change and/or the frequency component is/are mapped onto the severity of the current fluctuation and therefore onto the severity of the roadway unevenness. A road condition, in particular a road unevenness characteristic, is preferably ascertained on the basis of the torque change. In particular, possible road unevenness characteristics are the depth, severity and/or length of the roadway unevenness.

The current fluctuation may be displayed by mapping a representation of the current fluctuation as time signals or in the frequency domain onto a road condition or characteristic of roadway unevenness. The location of occurrence is preferably output together with the road condition. The display maps the current fluctuation or characteristics thereof (amplitude, duration, rate of change) onto the quantity or quality of the roadway unevenness.

The display preferably displays the current fluctuation as a frequency range representation. A frequency range representation of the current fluctuation is therefore mapped onto the quality or quantity of the roadway unevenness at the roadway unevenness point. The frequency range representation may be a full or partial spectral representation of the current fluctuation, in particular the amplitude(s) of one or more frequency components of the current fluctuation. Moreover, the current fluctuation may be displayed in the time range. Moreover, the current fluctuation may be displayed using a neural network. The neural network (or, in general terms, a system designed for machine learning) may describe an association between road condition (or characteristics of the roadway unevenness) and a current fluctuation which occurs in the drive as a result of the road condition.

Furthermore provided is a method for operating an electric drive of a vehicle depending on the condition of a road or depending on the roadway unevenness. Provision is made to ascertain a driving route. Before reaching the location of occurrence of the roadway unevenness, which has been ascertained according to the method as claimed in one of the preceding claims, a road unevenness warning is output. Alternatively or additionally, the electric drive or a chassis of the vehicle may be set for a roadway with greater unevenness, for example by increasing the resilience of the suspension and/or by reducing the maximum drive power. Furthermore, the vehicle wear index may be increased when driving over the location of occurrence at a minimum speed or above, i.e. at a speed which is too high and is therefore not adapted to the roadway unevenness, thereby increasing the wear on the vehicle.

A computer program product is described which is designed to execute the method. The computer program product has an input interface (a function head or the like) for values which describe the progression over time of the operating current. The computer program product has a program section which ascertains fluctuations over time in these values. The input interface is designed to transmit the values to the program section. The computer program product has an output interface (a function head or the like), which outputs an occurrence value, which indicates the active occurrence of the fluctuation, or the location of occurrence of the fluctuation as an active location of the vehicle at the time of the occurrence of the fluctuation. The program section is designed to transmit the occurrence value or the location of occurrence to the output interface. An ascertainment device may also be provided, which is designed to execute the method. The ascertainment device may be designed as a processor and an associated program memory, wherein a computer program is stored in the program memory, which computer program, when run on the processor, realizes the method.

1. A method for determining the condition of a roadway traveled by a vehicle having an electric drive, having the steps:
detecting the operating current of the electric drive;
ascertaining at least one current fluctuation in the operating current;
generating a signal which describes the location of occurrence of the current fluctuation; and
outputting the location of occurrence as a roadway unevenness point and/or outputting a variable which indicates the roadway unevenness.

2. The method as claimed in claim 1, wherein the occurrence is output to a database and stored therein, wherein the database is located inside or outside the vehicle.

3. The method as claimed in 1, wherein the duration of the current fluctuation and/or its severity and/or the type of current fluctuation is/are ascertained, the duration and/or the severity and/or the type is/are compared with a specified duration and/or type, a similarity value is ascertained, which is a measure of the similarity between the ascertained and the specified duration and/or type and the location of occurrence is only output if the similarity value exceeds a specified limit.

4. The method as claimed in claim 1, wherein, before ascertaining the current fluctuation, current changes linked to a change in a setpoint speed, which are received via an operating interface, are removed from the operating current.

5. The method as claimed in claim 1, wherein the ascertainment of the at least one current fluctuation in the operating current, the generation of the signal and/or the output of the location of occurrence only take place if the current fluctuation is ascertained at a vehicle speed above a specified speed threshold.

6. The method as claimed in claim 1, wherein the ascertainment of the at least one current fluctuation in the operating current provides for the amplitude and/or rate of change and/or the frequency components to be calculated as characteristics of the current fluctuation, wherein the characteristic is mapped onto a torque change which occurs in the electric drive and is the cause of the current fluctuation.

7. The method as claimed in claim 6, wherein a road condition, in particular a road unevenness characteristic, is ascertained on the basis of the torque change.

8. The method as claimed in claim 1, wherein the current fluctuation is mapped onto a road condition by mapping a representation of the current fluctuation as time signals or in the frequency domain onto a road condition and the location of occurrence is output together with the road condition.

9. The method as claimed in claim 8, wherein the display is a display which displays the current fluctuation as a frequency domain representation and/or which displays the current fluctuation using a neural network which describes an association between a road condition and a current fluctuation which occurs in the drive as a result of the road condition.

10. The method for operating an electric drive of a vehicle depending on the condition of a road, wherein a driving route is ascertained and, before reaching the location of occurrence, which has been output according to the method as claimed in claim 1, a road unevenness warning is output and/or the electric drive or a chassis of the vehicle is set for a roadway with greater unevenness and/or a vehicle wear index is increased when driving over the location of occurrence at a minimum speed or above.

11. A computer program product, designed to execute the method as claimed claim 1, wherein the computer program product has an input interface for values which describe the progression over time of the operating current, a program section, which ascertains fluctuations over time in these values and has an output interface, which outputs an output value which indicates the active occurrence of the fluctuation or the location of occurrence of the fluctuation as an active location of the vehicle at the time of the occurrence of the fluctuation.

12. The method as claimed in claim 2, wherein the duration of the current fluctuation and/or its severity and/or the type of current fluctuation is/are ascertained, the duration and/or the severity and/or the type is/are compared with a specified duration and/or type, a similarity value is ascertained, which is a measure of the similarity between the ascertained and the specified duration and/or type and the location of occurrence is only output if the similarity value exceeds a specified limit.
